(19) United States
(12) Patent Application Publication
(10) Pub. No.: US 2026/0205780 A1
(43) Pub. Date: Jul. 16, 2026

(54) WIRELESS SENSING OVER A LARGE BANDWIDTH

(71) Applicant: Telefonaktiebolaget LM Ericsson (publ), Stockholm (SE)

(72) Inventors: Miguel LOPEZ, Solna (SE); Leif WILHELMSSON, Lund (SE)

(21) Appl. No.: 19/133,777

(22) PCT Filed: Dec. 2, 2022
(86) PCT No.: PCT/EP2022/084284

§ 371 Date: May 29, 2025

(51) Int. Cl. H04W 4/38

(52) U.S. Cl. CPC H04W 4/38

(57) ABSTRACT

Wireless sensing in a packet-based communication network is disclosed. The packet-based communication network operates according to a predefined channelization structure with sub-channels. The wireless sensing is performed over a sensing frequency range with a sensing bandwidth which comprises a plurality of the sub-channels. The method comprises causing transmission of a plurality of sensing bursts from a sensing transmitter, wherein each sensing burst comprises a respective collection of sensing packets, wherein each sensing packet is transmitted over one or more of the sub-channels of the sensing frequency range and has a packet bandwidth which is smaller than the sensing bandwidth, and wherein at least two sensing packets of each respective collection are transmitted over different sub-channels.

### TECHNICAL FIELD

The present disclosure relates generally to the field of wireless sensing. More particularly, it relates to wireless sensing over relatively large bandwidths.

### BACKGROUND

A purpose of wireless sensing—also referred to herein as sensing—is to detect physical changes in an environment (e.g., movement of persons or objects). There are a number of possible applications for wireless sensing, including home security (e.g., intruder detection, burglar alarm), control of home appliances (e.g., smart lighting), and health care (e.g., monitoring vital signs such as heart rate, breathing, etc.).

Wireless sensing is a useful enhancement for radio technologies that have been designed primarily for communications. For example, wireless sensing can be performed by letting devices, that are compliant with the specification requirements for an IEEE 802.11 station (STA), act as sensing transmitter and sensing receiver to detect changes in a wireless propagation channel between the devices. Generally, IEEE 802.11 stations are classified into Access Point Stations (AP STAs) and non-Access Point Stations (non-AP STAs); sometimes simply referred to as APs and STAs, respectively.

A sensing receiver typically receives multiple physical layer packets (sensing packets) transmitted by a sensing transmitter, and performs sensing measurements on each of the packets. The sensing measurements are used to detect changes (time variations) in the wireless propagation channel. Detected changes are interpreted as occurrence of events and the events may be classified based on the nature of the detected changes.

In some situations (e.g., depending on the sensing application), it may be desirable to perform sensing measurements over a relatively large sensing bandwidth (e.g., to achieve high resolution for the sensing). This may be problematic when the sensing transmitter and/or the sensing receiver have bandwidth limitations which cannot meet the sensing bandwidth (e.g., different types of STAs may have different bandwidth capabilities). Alternatively or additionally, it may be problematic when the underlying communication technology has bandwidth limitations which cannot meet the sensing bandwidth (e.g., different IEEE 802.11 bands may have different bandwidth requirements). Yet alternatively or additionally, it may be problematic when the transmission power is limited so that the received signal quality is degraded due to that the limited transmission power is spread over the relatively large sensing bandwidth (e.g., different types of STAs may have different output power possibilities). Generally, received signal quality may be expressed in any suitable metric (e.g., signal-to-noise ratio, SNR, per received packet).

Furthermore, in some situations (e.g., depending on the sensing application), it may be desirable to perform sensing measurements at regular time intervals. This may be problematic in the context of IEEE 802.11 since the listen-before-talk (LBT) requirement entails somewhat unpredictable channel access. The same problem applies to any communication environment imposing an LBT procedure (or similar) for a transmitter to gain access to the channel.

Therefore, there is a need for alternative approaches to wireless sensing. Preferably, such approaches enable sensing measurements over a relatively large sensing bandwidth. For example, the approaches could preferably enable sensing measurements over a relatively large sensing bandwidth with acceptable received signal quality. Alternatively or additionally, the approaches could preferably enable sensing measurements to be performed at regular time intervals.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like. It is an object of some embodiments to solve or mitigate, alleviate, or eliminate at least some of the above or other disadvantages.

A first aspect is a method for wireless sensing in a packet-based communication network, wherein the packet-based communication network operates according to a predefined channelization structure with sub-channels, and wherein the wireless sensing is performed over a sensing frequency range with a sensing bandwidth which comprises a plurality of the sub-channels. The method comprises causing transmission of a plurality of sensing bursts from a sensing transmitter, wherein each sensing burst comprises a respective collection of sensing packets. Each sensing packet is transmitted over one or more of the sub-channels of the sensing frequency range and has a packet bandwidth which is smaller than the sensing bandwidth, and at least two sensing packets of each respective collection are transmitted over different sub-channels.

In some embodiments, the sub-channel used for transmission is varied using frequency hopping.

In some embodiments, the packet bandwidth is associated with a sensing receiver bandwidth, and/or with a packet power metric.

In some embodiments, transmission of one of the sensing bursts covers the sensing frequency range and/or utilizes all sub-channels of the sensing frequency range, or covers only part of the sensing frequency range and/or utilizes only a subset of the sub-channels of the sensing frequency range.

In some embodiments, transmission of the plurality of sensing bursts covers the sensing frequency range and/or utilizes all sub-channels of the sensing frequency range, or covers only part of the sensing frequency range and/or utilizes only a subset of the sub-channels of the sensing frequency range.

In some embodiments, the method further comprises causing a sensing receiver to perform sensing measurements based on the sensing packets.

In some embodiments, causing the sensing receiver to perform sensing measurements comprises providing information indicative of a duration between sensing packets transmitted over a same sub-channel.

In some embodiments, the method further comprises causing interpolation, and/or extrapolation, of sensing measurements performed for utilized sub-channels, to provide sensing measurement estimations for un-utilized sub-channels.

In some embodiments, the method further comprises determining one or more of: a sensing session duration, number of bursts in a sensing session, a burst duration, number of sensing packets per burst, a burst rate within sensing session, a packet rate within bursts, a sub-channel change rate, and a sequence length for sub-channel changing.

In some embodiments, the sensing frequency range is comprised in, and/or comprises, unlicensed frequency spectrum.

In some embodiments, the transmission of the sensing bursts from the sensing transmitter is compliant with a Bluetooth specification and/or an IEEE 802.11 specification.

In some embodiments, at least one of the sub-channels is used for sensing transmission at least twice during the sensing session.

In some embodiments, time variations of the at least one sub-channel are detected by comparing sensing measurements corresponding to different sensing transmissions for the at least one sub-channel during the sensing session.

In some embodiments, the transmission of a plurality of sensing bursts implements probing of the sensing frequency range by respective probing of at least some of the sub-channels.

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus for wireless sensing in a packet-based communication network, wherein the packet-based communication network operates according to a predefined channelization structure with sub-channels, and wherein the wireless sensing is performed over a sensing frequency range with a sensing bandwidth which comprises a plurality of the sub-channels. The apparatus comprises controlling circuitry configured to cause transmission of a plurality of sensing bursts from a sensing transmitter, wherein each sensing burst comprises a respective collection of sensing packets. Each sensing packet is transmitted over one or more of the sub-channels of the sensing frequency range and has a packet bandwidth which is smaller than the sensing bandwidth, and at least two sensing packets of each respective collection are transmitted over different sub-channels.

A fourth aspect is a sensing control node comprising the apparatus of the third aspect.

A fifth aspect is a wireless sensing system comprising the sensing control node of the fourth aspect, a sensing transmitter configured to transmit the plurality of sensing bursts, a sensing receiver configured to perform sensing measurements based on the sensing packets, and a wireless sensing node configured to determine a wireless sensing result based on the sensing measurements.

In some embodiments, any of the above aspects may additionally have features identical with or corresponding to any of the various features as explained above for any of the other aspects.

An advantage of some embodiments is that alternative approaches to wireless sensing are provided.

An advantage of some embodiments is that sensing measurements over a relatively large sensing bandwidth are enabled.

An advantage of some embodiments is that sensing measurements over a relatively large sensing bandwidth are enabled with higher received signal quality than for other approaches.

An advantage of some embodiments is that performance of sensing measurements at regular time intervals is enabled.

An advantage of some embodiments is that wireless sensing may be applied in the context of Bluetooth (i.e., letting devices, that are compliant with the specification requirements for Bluetooth communication, act as sensing transmitter and sensing receiver). In particular, since LBT is not imposed for Bluetooth, sensing packets can be transmitted at predetermined times and performance of sensing measurements at regular time intervals is enabled.

Furthermore, even though Bluetooth packets are limited in bandwidth, frequency hopping enables sensing of relatively large sensing bandwidths.

An advantage of some embodiments is that wireless sensing may be applied in an improved manner in the context of IEEE 802.11. In particular, relatively large sensing bandwidths may be used without sacrificing received signal quality.

Even though the LBT procedure is imposed for IEEE 802.11, transmission of sensing packets—and performance of sensing measurements—at regular time intervals is enabled by performing LBT initially (e.g., at the start of a sensing session) to acquire the full channel corresponding to the sensing bandwidth. Thus, a sensing session may correspond to a transmission opportunity (TXOP) according to some embodiments.

Furthermore, application of frequency hopping enables sensing of relatively large sensing bandwidths without sacrificing received signal quality (since the power spectral density can be increased, which increases the SNR higher and renders the sensing measurement less noisy).

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2 is a schematic frequency diagram illustrating an example sensing frequency range and an example packet bandwidth in relation to an example channelization structure according to some embodiments;

FIG. 3 is a signaling diagram illustrating example signaling according to some embodiments;

FIG. 4 is a schematic time diagram illustrating sensing packet transmission according to some embodiments;

FIG. 5 is a schematic block diagram illustrating an example apparatus according to some embodiments;

FIG. 6 is a schematic block diagram illustrating an example wireless sensing system according to some embodiments;

FIG. 7 is a schematic block diagram illustrating an example wireless sensing system deployment according to some embodiments; and

FIG. 8 is a schematic drawing illustrating an example computer readable medium according to some embodiments.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, alternative approaches to wireless sensing are provided. Some embodiments enable sensing measurements over a relatively large sensing bandwidth (e.g., to provide high resolution). Particularly, some embodiments enable sensing measurements over a relatively large sensing bandwidth with relatively high received signal quality. Furthermore, some embodiments enable sensing measurements to be performed at regular time intervals.

Generally, a communication device that transmits packets that are used for sensing measurements is called a sensing transmitter, while a communication device that performs sensing measurements is called a sensing receiver.

It should be noted that, while sensing measurements are performed by a sensing receiver, the processing of the sensing measurements (e.g., to detect changes in the wireless propagation channel) may be performed by the sensing receiver that performed the measurements, by the sensing transmitter, or by any other suitable device to which the sensing measurements are provided.

Furthermore, it should be noted that the sensing results of the processing of the sensing measurements (e.g., events indicating physical changes) may be used by the device that processes the sensing measurements, or by any other suitable device to which the sensing results are provided.

A device processing the sensing measurements and/or using the sensing result is termed herein as a wireless sensing node.

The sensing transmitter and/or the sensing receiver may be controlled by a sensing controller (e.g., a sensing control node). The sensing controller may be comprised in the sensing transmitter, in the sensing receiver, or in any other suitable device (e.g., a wireless sensing node).

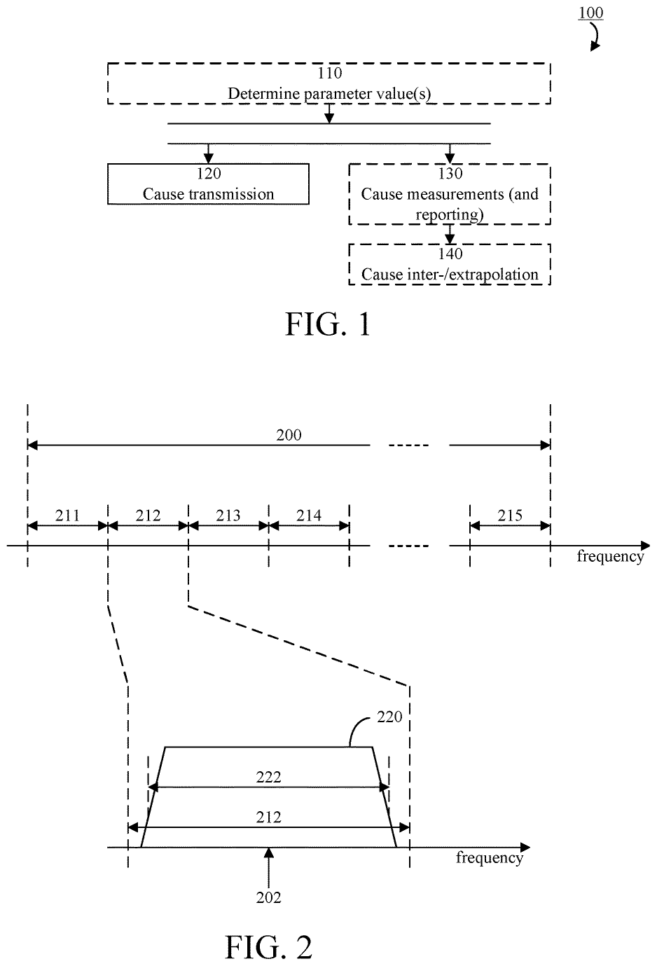

FIG. 1 illustrates an example method 100 according to some embodiments. For example, the method 100 may be performed by a sensing controller.

The method 100 is for wireless sensing in a packet-based communication network, wherein the packet-based communication network operates according to a predefined channelization structure with (typically non-overlapping) sub-channels. The wireless sensing of the method 100 is performed over a sensing frequency range with a sensing bandwidth which comprises a plurality of the sub-channels.

For example, the packet-based communication network may be compliant with Bluetooth communication requirements and/or IEEE 802.11 communication requirements.

Alternatively or additionally, the sensing frequency range may comprise, or be comprised in, an unlicensed frequency spectrum.

As illustrated by step 120, the method 100 comprises causing transmission of a plurality of (at least two) sensing bursts from a sensing transmitter. The transmission of the plurality of sensing bursts may define a sensing session.

When the method 100 is performed by the sensing transmitter (e.g., when the sensing controller is comprised in the sensing transmitter), step 120 may comprise transmitting the plurality of sensing bursts. When the method 100 is not performed by the sensing transmitter, step 120 may comprise controlling the sensing transmitter to transmit the plurality of sensing bursts (e.g., by providing transmission instructions to the sensing transmitter using control signaling).

For example, the transmission of the sensing bursts from the sensing transmitter may be compliant with a Bluetooth specification. Alternatively, the transmission of the sensing bursts from the sensing transmitter may be compliant with an IEEE 802.11 specification (where an AP may act as sensing transmitter or as sensing receiver, and a STA may act as sensing transmitter or as sensing receiver).

A combination of Bluetooth and IEEE 802.11 transmissions may also be applied as sensing packets. For example, a scenario may be considered where an sensing transmitter AP supports both Bluetooth and IEEE 802.11 and is associated with a plurality of sensing receivers, wherein at least one sensing receiver only supports Bluetooth and at least one sensing receiver only supports IEEE 802.11. Then, the AP can transmit Bluetooth sensing packets and IEEE 802.11 sensing packets in a mixed fashion to exploit sensing by all sensing receivers.

Generally, when a Bluetooth specification or an IEEE 802.11 specification is referred to herein, it is meant to encompass any suitable specification, such as—for example—Bluetooth 5.3 or IEEE 802.11-2020, respectively.

In the context of Bluetooth, each sub-channel may, for example, correspond to a 1 MHz bandwidth or a 2 MHz bandwidth, and a sensing packet may, for example, correspond to a packet carrying no data but only the fields needed for synchronization and a header, or a packet specifically designed for sensing in that the payload contains symbols that are suitable for channel estimation rather than usual data. In the context of IEEE 802.11, each sub-channel may, for example, correspond to 20 MHz, and a sensing packet may, for example, correspond to a null data packet (NDP).

Each sensing burst comprises a respective collection of (at least two) sensing packets. Each sensing packet is transmitted over one or more of the sub-channels of the sensing frequency range (typically, over a single sub-channel, or over two or more adjacent sub-channels).

Each sensing packet has a packet bandwidth which is smaller than the sensing bandwidth. For example, the packet bandwidth may be equal to, or smaller than, the sub-channel bandwidth.

In some embodiments, the packet bandwidth is associated with a sensing receiver bandwidth. For example, the packet bandwidth may be equal to, or smaller than, a maximum bandwidth of the sensing receiver.

Alternatively or additionally, the packet bandwidth may be associated with a packet power metric. For example, the packet bandwidth may enable a maximum transmission power to achieve a received signal quality (e.g., SNR) above a quality threshold value. To this end, it should be noted that sensing may have other (typically higher) requirements on received signal quality than communication of the underlying communication network has.

In some embodiments, the packet bandwidth is (dynamically) selected based on conditions at the sensing receiver(s). Such conditions may be reported by the sensing receiver or may be estimated at the sensing transmitter based on a channel reciprocity assumption. For example, when the receiver conditions indicate a relatively high path loss and/or a relatively high noise level, the packet bandwidth may be selected as relatively small. Alternatively or additionally, when the receiver conditions indicate that a particular transmission power and packet bandwidth yields a particular SNR, the packet bandwidth (and/or the transmission power) may be dynamically adapted to meet an SNR condition (e.g., achieve an SNR above an SNR threshold value).

Yet alternatively or additionally, the packet bandwidth may be associated with a packet bandwidth constraint of the underlying communication network (e.g., constraints of Bluetooth communication).

At least two sensing packets of each respective collection of sensing packets are transmitted over different sub-channels. Thereby, sensing measurements are enabled for a sensing bandwidth which is (substantially) larger than the packet bandwidth. Typically, several (e.g., a majority, or all) sensing packets of each respective collection of sensing packets are transmitted over different sub-channels.

Generally, variation of the sub-channel used for transmission may be accomplished in any suitable way.

In some embodiments, a pre-determined order may be applied to vary the sub-channel used for transmission. For example, sweeping of the sub-channels (from low to high frequency, or vice versa) may be applied to vary the sub-channel used for transmission.

In some embodiments, pseudo-randomization may be applied to vary the sub-channel used for transmission. For example, frequency hopping (e.g., according to Bluetooth principles, or any other suitable approach) may be applied to vary the sub-channel used for transmission.

Parameter value(s) to be used for the transmission may be pre-determined or dynamically variable. As illustrated by optional step 110, the method 100 may comprise determining one or more (dynamically variable) parameter value(s).

Some example parameter values that might be relevant for the transmission include one or more of: a sensing session duration, a sensing session start time, a sensing session end time, a number of bursts in a sensing session, a burst duration, a number of sensing packets per burst, a burst rate within a sensing session (may also be expressed via a burst period; how often bursts are transmitted), a packet rate within bursts (may also be expressed via a packet period; how often packets are transmitted within the bursts), a sub-channel change rate (i.e., how often the sub-channel used for transmission is varied; e.g., a frequency hopping rate), and a sequence length for sub-channel changing (i.e., how often the sub-channel variation pattern is repeated; e.g., a frequency hopping periodicity and/or a length of a frequency hopping sequence).

Another example parameter that might be relevant for the transmission is the sub-channel variation pattern (e.g., a frequency hopping sequence and/or a seed/phase value for a frequency hopping sequence).

According to some embodiments, particularly interesting parameters relate to the duration between sensing packets transmitted over a same sub-channel (since that relates to the time resolution of sensing measurements for that sub-channels). The duration between sensing packets transmitted over a same sub-channel may be indicated explicitly or implicitly (e.g., via one or more of the example parameters presented above).

It should be noted that the duration between sensing packets transmitted over a same sub-channel may be the same for all sub-channels, or may vary between different sub-channels.

Furthermore, the duration between sensing packets transmitted over a same sub-channel may be the same over time (e.g., within a sensing session), or may vary over time.

The sub-channel change rate may coincide with the packet rate within bursts, or may differ therefrom (e.g., the sub-channel change rate may be lower than the packet rate within bursts, so that two or more subsequent packets may be transmitted using the same sub-channel).

Generally, it should be noted that some parameters may depend on each other, and that determination of some parameter values may directly yield other parameter values. For example, the burst duration and the packet rate within bursts yields the number of sensing packets per burst.

The determination in step 110 may be performed according to any suitable approach. For example, one or more parameter value(s) may depend on the sensing application.

A particularly relevant example is when the time between packets transmitted using the same sub-channel is dependent on the sensing application (i.e., the sensing application has requirements on the timing resolution of the sensing measurements). Assuming that each burst utilizes all sub-channels of the sensing frequency range once, such requirements may, for example, translate to requirements on the burst rate.

Another relevant example is when the number of packets transmitted using the same sub-channel within a sensing session is dependent on the sensing application (i.e., the sensing application has requirements on how many packets the sensing measurements should be based on). Assuming that each burst utilizes all sub-channels of the sensing frequency range once, such requirements may, for example, translate to requirements on the number of bursts in a session.

In some embodiments, burst duration, hopping sequence, and hopping rate are selected such that the hopping rate causes the hopping sequence to be within one burst. Exemplifying with reference to a Bluetooth wireless network, the burst duration could be 10 ms and, if a hopping sequence with length 32 and hopping rate 3200 hops/s is selected, all hops of the hopping sequence can be performed in one burst. Exemplifying with reference to an IEEE 802.11 wireless network where the operating bandwidth is 160 MHz and is divided into four sub-channels of 40 MHz each, the burst duration could be 1 ms and, if a hopping sequence with length 4 (i.e., covering all sub-channels) and hopping rate 4000 hops/s is selected, all hops of the hopping sequence can be performed in one burst

In some embodiments, the transmission instructions of step 120 may comprise, or be otherwise indicative of, one or more (dynamically variable) parameter value(s) to be used for the transmission.

As illustrated by optional step 130, the method 100 may further comprise causing one or more sensing receiver(s) to perform sensing measurements based on the sensing packets. Alternatively, the sensing receiver(s) may be pre-configured to perform the sensing measurements.

When the method 100 is performed by one of the sensing receiver(s) (e.g., when the sensing controller is comprised in the sensing receiver), step 130 may comprise performing the sensing measurements. For sensing receiver(s) not performing the method 100, step 130 may comprise controlling the sensing receiver(s) to perform the sensing measurements (e.g., by providing measurement instructions to the sensing receiver(s) using control signaling).

In some embodiments, the measurement instructions of step 130 may comprise, or be otherwise indicative of, one or more (dynamically variable) parameter value(s) that are to be used for the transmission. For example, the measurement instructions of step 130 may—explicitly or implicitly—inform the sensing receiver of a time between packets transmitted using the same sub-channel.

Particularly, step 130 may comprise providing, to the sensing receiver(s), information indicative of the duration between sensing packets transmitted over a same sub-channel.

In some embodiments, step 130 may also include causing the one or more sensing receiver(s) to report a result of the sensing measurements.

When the method 100 is performed by one of the sensing receiver(s) (e.g., when the sensing controller is comprised in the sensing receiver), step 130 may comprise transmitting a sensing measurement report. For sensing receiver(s) not performing the method 100, step 130 may comprise controlling the sensing receiver(s) to transmit a sensing measurement report (e.g., by providing reporting instructions to the sensing receiver(s) using control signaling).

In some embodiments, the reporting instructions of step 130 may comprise, or be otherwise indicative of, an intended receiver of the report and/or a report content.

Generally, the sensing measurements may be performed in any suitable way for each of the relevant sub-channels. For example, the sensing measurements may comprise one or more of: signal strength measurements (e.g., received signal strength indicator, RSSI, reference signal received power, RSRP, etc.), channel measurements (e.g., channel state information, CSI, frequency response, etc.), and signal quality measurements (e.g., reference signal received quality, RSRQ, signal-to-noise ratio, SNR, etc.).

Also generally, the report may comprise any suitable content. For example, the report may comprise a raw results of the sensing measurements (e.g., per sub-channel: signal strength, channel response, signal quality, etc.), and/or some processed results of the sensing measurements (e.g., combined over the sensing bandwidth: signal strength, channel response, signal quality, etc.). Alternatively or additionally, the report may comprise a sensing result (e.g., the detection of an event indicating a physical change), and/or some intermediate metric (e.g., a variation of the propagation channel as derived from the sensing measurements).

Generally, combination of sensing results from the different sub-channels may be performed in any suitable manner. For example, different measurement results may be given different weights depending on their reliability (e.g., measurements obtained on a sub-channel that is heavily interfered may be given a lower weight than other measurements; or may be completely ignored).

As already mentioned, at least two (typically several; e.g., all) sensing packets of each respective collection of sensing packets are transmitted over different sub-channels, which enables sensing measurements for a sensing bandwidth which is (substantially) larger than the packet bandwidth.

According to some embodiments, all bursts in the plurality of sensing bursts use the same set of sub-channels and apply the sub-channels in the same order. Alternatively, some bursts may use the same set of sub-channels, but apply the sub-channels in different orders. Yet alternatively, some bursts may use different sets of sub-channels. Typically, but not necessarily, each burst uses a particular sub-channel at most once.

The transmission of one of the sensing bursts may cover the entire sensing frequency range (e.g., by utilizing all sub-channels of the sensing frequency range). Thereby, two bursts enable a sensing receiver to perform sensing measurements of the entire sensing frequency range.

In some embodiments, the transmission of one of the sensing bursts may cover only part of the sensing frequency range (e.g., by utilizing only a subset of the sub-channels of the sensing frequency range).

When the transmission of one of the sensing bursts covers only part of the sensing frequency range, transmission of the plurality of sensing bursts may cover the entire sensing frequency range (e.g., by utilizing all sub-channels of the sensing frequency range). Thereby, the plurality of bursts together enable a sensing receiver to perform sensing measurements of the entire sensing frequency range (at least when each sub-channel of the sensing frequency range is utilized at least twice in the plurality of sensing bursts).

In some embodiments, when the transmission of one of the sensing bursts covers only part of the sensing frequency range, transmission of the plurality of sensing bursts may also cover only part of the sensing frequency range (e.g., by utilizing only a subset of the sub-channels of the sensing frequency range).

When the transmission of the plurality of sensing bursts covers only part of the sensing frequency range, the method 100 may comprise causing interpolation and/or extrapolation of sensing measurements performed for utilized sub-channels as illustrated by optional step 140. Thereby, sensing measurement estimations may be provided also for un-utilized sub-channels.

It should be noted that interpolation/extrapolation of sensing measurements may, alternatively or additionally, be used in other situations. For example, sensing measurements performed for a sub-channel may be supplemented by interpolation/extrapolation of sensing measurements performed for other sub-channels (e.g., to improve reliability and/or accuracy for the sub-channel).

Generally, interpolation/extrapolation may be performed by the sensing receiver (in which case the report may comprise interpolation/extrapolation results), or by any other suitable device.

Step 140 may comprise performing the interpolation/extrapolation, and/or controlling another device to perform interpolation/extrapolation (e.g., by providing interpolation/extrapolation instructions using control signaling).

Generally, control signaling may be provided directly by a sensing control node to the device to be controlled (e.g., sensing transmitter or sensing receiver), or control signaling may be provided by a sensing control node to the device to be controlled via one or more other device(s) (e.g., a wireless sensing node).

Hence, a wideband channel is sensed by probing (performing sensing measurements on) a plurality of sub-channels during a sensing session. Each sub-channel to be probed is used for sensing transmission at least twice during the sensing session, and time variations of the sub-channel are detected by comparing the corresponding sensing measurements. The time duration between sensing transmissions for a same sub-channel is known by the device that does the comparison (e.g., the sensing receiver). For example, the time duration between sensing transmissions for a same sub-channel may be fixed. A collective indication of propagation channel time variations may be achieved by combining the sensing measurements for several (e.g., all) sub-channels.

In some embodiments, each burst uses the same sub-channels for sensing transmission. For example, each burst may use all sub-channels within the sensing frequency range for sensing transmission, or each burst may use a sub-set of the sub-channels within the sensing frequency range for sensing transmission. As mentioned before, interpolation/extrapolation may be used in the latter case to provide an estimation for the other sub-channels within the sensing frequency range.

When each burst uses the same sub-channels for sensing transmission, order of the sub-channels within each burst may be the same for all bursts, or may be different for at least two (e.g., all) of the bursts. In the former case, the time duration between sensing transmissions for a same sub-channel is fixed (equal to the burst period), and in the latter case the time duration between sensing transmissions for a same sub-channel is variable.

In some embodiments, the sub-channels used for sensing transmission varies between the bursts. For example, the sub-channels within the sensing frequency range may be divided into two or more sub-sets (typically equally sized). Then, each burst may use one or more of the sub-sets for sensing transmission. The same or different order may be applied within the sub-set each time it is used. Thereby, the bursts may alternately (e.g., in a cyclic fashion) use one or more of the sub-sets for sensing transmission. These approaches may be beneficial when short bursts and a relatively large sensing bandwidth are preferable.

Some examples will now be given for a situation when there are 32 sub-channels with center frequencies f(1), . . . , f(32).

In a first example, the 32 sub-channels are divided into two sub-sets (e.g., f(1), . . . , f(16) and f(17), . . . , f(32)) and the bursts (at least four bursts) alternate between the two sub-sets.

In a second example, the 32 sub-channels are divided into four sub-sets (e.g., S₁=f(1), . . . , f(8), S₂=(9), . . . , f(16), S₃=(17), . . . , f(24), and S₄=f(25), . . . , f(32)) and the bursts (at least eight bursts) uses the four sub-sets in a cyclic fashion.

In a third example, the 32 sub-channels are divided into four sub-sets (e.g., S₁, S₂, S₃, S₄ as above) and the bursts (at least four bursts) uses the four sub sets as follows: Burst #1 uses S₁ and S₂, Burst #2 uses S₁ and S₃, Burst #3 uses S₂ and S₄, Burst #4 uses S₃ and S₄, Burst #5 uses S₁ and S₂, and so on.

Numerous other ways of organizing the use of the sub-channels for sensing transmission are possible, than what has been explicitly described herein. It should be understood that all such variations are intended as encompassed, and that the explicitly described ways of organizing the use of the sub-channels for sensing transmission are not intended as limiting.

FIG. 2 schematically illustrates an example sensing frequency range 200 and an example packet bandwidth 222 in relation to an example channelization structure. For example, FIG. 2 may be seen as an exemplification of the sensing frequency range and channelization structure of the method 100 of FIG. 1.

The channelization structure comprises sub-channels and the sensing frequency range 200 comprises a plurality of the sub-channels; namely sub-channels 211, 212, 213, 214, 215. It should be noted that the sensing frequency range may comprise all sub-channels of the channelization structure, or a sub-set thereof.

An example packet 220 is illustrated as transmitted in sub-channel 212 using a center frequency (e.g., a carrier) 202. The example packet has a packet bandwidth 222, which is smaller than the bandwidth of the sub-channel 212.

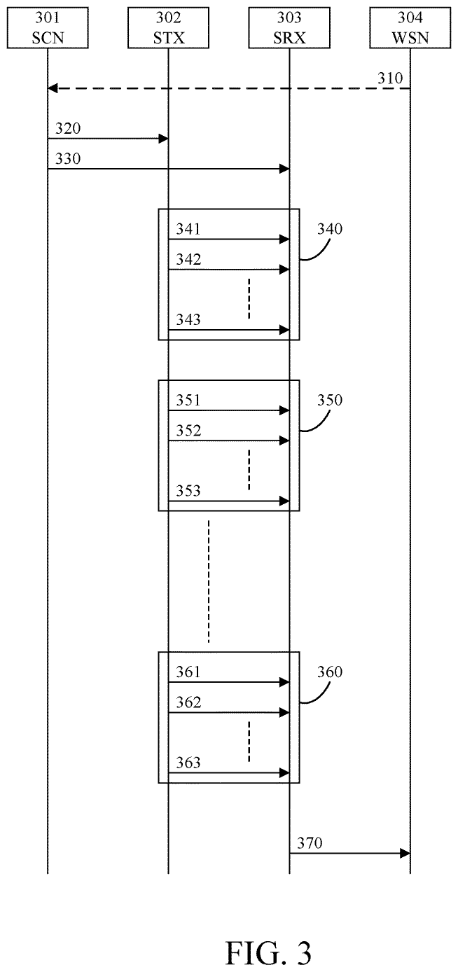

FIG. 3 illustrates example signaling according to some embodiments (e.g., during an example sensing session). The example signaling is among a sensing control node (SCN) 301, a sensing transmitter (STX) 302, a sensing receiver (SRX) 303, and a wireless sensing node (WSN) 304.

For example, FIG. 3 may be seen as an exemplification of signaling caused by a sensing control node 301 performing the method 100 of FIG. 1. As already mentioned, it should be noted that the sensing control may be performed by a separate sensing control node, by the sensing transmitter, by a sensing receiver, or by the wireless sensing node. Hence, some of the signaling illustrated in FIG. 3 may take the form of internal signaling within a device according to some embodiments.

The sensing control node 301 causes (compare with step 120 of FIG. 1) transmission of a plurality of sensing bursts 340, 350, 360 from the sensing transmitter 302. More particularly, the sensing control node 301 transmits control signaling 320 to the sensing transmitter 302, thereby controlling the sensing transmitter 302 to transmit the plurality of sensing bursts 340, 350, 360.

Each sensing burst 340, 350, 360 comprises a respective collection of sensing packets 341, 342, 343; 351, 352, 353; 361, 362, 363, and at least some sensing packets of each respective collection of sensing packets are transmitted over different sub-channels, as already elaborated on in connection with FIG. 1.

The sensing control node 301 also causes (compare with step 130 of FIG. 1) the sensing receiver 303 to perform sensing measurements based on the sensing packets 341, 342, 343; 351, 352, 353; 361, 362, 363. More particularly, the sensing control node 301 transmits control signaling 330 to the sensing receiver 303, thereby controlling the sensing receiver 303 to perform the sensing measurements.

At the end of the sensing session, the sensing receiver 303 transmits a report 370 to the wireless sensing node 304, as already elaborated on in connection with FIG. 1. For example, the sensing control node 301 may cause (compare with step 130 of FIG. 1) the sensing receiver 303 to transmit the report 370. More particularly, the control signaling 330 may control the sensing receiver 303 to transmit the report 370.

In some embodiments, the sensing session is initiated by the wireless sensing node 304, which is indicated in FIG. 3 by a sensing request 310 transmitted from the wireless sensing node 304 to the sensing control node 301. The sensing request 310 may convey requirements for the sensing session (e.g., based on the sensing application that the wireless sensing device 304 runs). For example, the sensing request 310 may be indicative of one or more parameter value(s) to be used by the sensing transmitter 302, and/or one or more such parameter value(s) may be determined (compare with step 110 of FIG. 1) by the sensing control node 301 responsive to the sensing request 310.

In a variant of FIG. 3, the SCN 301 and the WSN 304 is comprised in the sensing transmitter 302. Then, the control signaling 320 corresponds to internal functions of the sensing transmitter 302, a sensing request corresponding to 330 may be sent from the sensing transmitter 302 to the sensing receiver 303 to initiate the sensing session, and the report 370 may be transmitted from the sensing receiver 303 to the sensing transmitter 302 at the end of the sensing session.

In another variant of FIG. 3, the SCN 301 and the WSN 304 is comprised in the sensing receiver 303. Then, the control signaling 330 corresponds to internal functions of the sensing receiver 303, a sensing request corresponding to 320 may be sent from the sensing receiver 303 to the sensing transmitter 302 to initiate the sensing session, and the report 370 corresponds to internal functions of the sensing receiver 303 at the end of the sensing session.

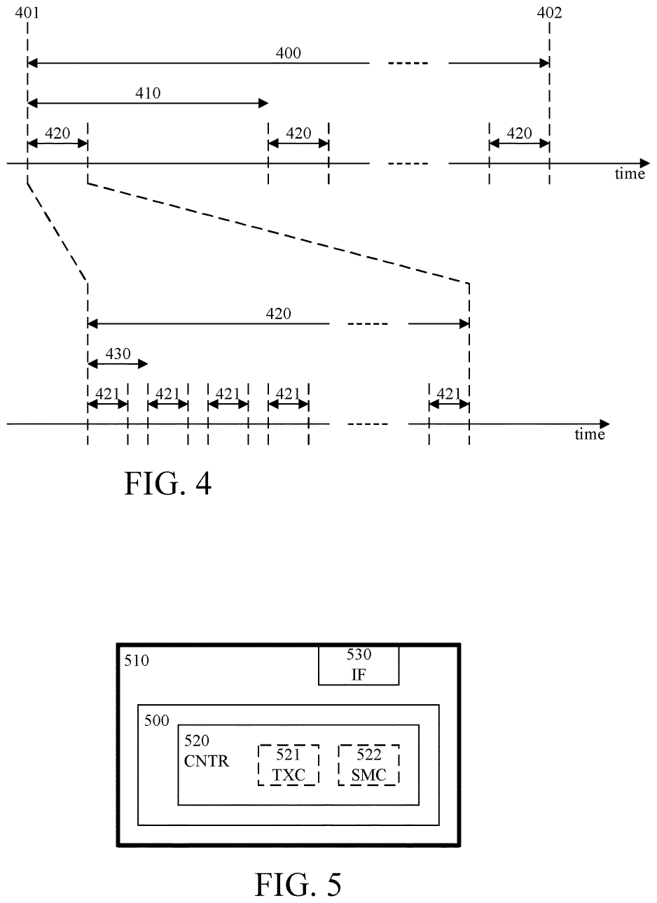

FIG. 4 schematically illustrates sensing packet transmission according to some embodiments. For example, FIG. 4 may be seen as an exemplification of some of the parameters mentioned in connection to FIG. 1.

FIG. 4 shows a sensing session duration 400, with a sensing session start time 401, and a sensing session end time 402. A number of bursts with burst duration 420 are included in the sensing session, and each burst includes a number of sensing packets with packet duration 421.

The burst period is illustrated by the time 410 between the start of one burst and the start of the directly subsequent burst. Similarly, the packet period within bursts is illustrated by the time 430 between the start of one packet and the start of the directly subsequent packet within a burst.

FIG. 5 schematically illustrates an example apparatus 500 according to some embodiments.

The apparatus 500 is an apparatus for wireless sensing in a packet-based communication network, wherein the packet-based communication network operates according to a predefined channelization structure with sub-channels, and wherein the wireless sensing is performed over a sensing frequency range with a sensing bandwidth which comprises a plurality of the sub-channels.

For example, the apparatus 500 may be comprised in an electronic device 510 (e.g., a sensing control node; compare with 301 of FIG. 3). Alternatively or additionally, the apparatus 500 may be configured to perform one or more steps of the method 100 of FIG. 1.

The apparatus 500 comprises a controller (CNTR; e.g., controlling circuitry or a control module) 520.

The controller 520 is configured to cause transmission of a plurality of sensing bursts from a sensing transmitter (compare with step 120 of FIG. 1 and signaling 320 of FIG. 3).

To this end, the controller 520 may comprise, or be otherwise associated with (e.g., connected, or connectable, to) a transmission controller (TXC; e.g., transmission controlling circuitry or a transmission control module) 521. The transmission controller 521 may be configured to cause the transmission of the sensing bursts (e.g., by providing control signaling to the sensing transmitter via an interface, IF, 530).

As indicated previously, each sensing burst comprises a respective collection of sensing packets, wherein each sensing packet is transmitted over one or more of the sub-channels of the sensing frequency range and has a packet bandwidth which is smaller than the sensing bandwidth, and wherein at least two sensing packets of each respective collection are transmitted over different sub-channels.

The controller 520 may also be configured to cause a sensing receiver to perform sensing measurements based on the sensing packets (compare with step 130 of FIG. 1 and signaling 330 of FIG. 3).

To this end, the controller 520 may comprise, or be otherwise associated with (e.g., connected, or connectable, to) a sensing measurement controller (SMC; e.g., sensing measurement controlling circuitry or a sensing measurement control module) 522. The sensing measurement controller 522 may be configured to cause the sensing measurements to be performed (e.g., by providing control signaling to the sensing receiver via the interface 530).

According to some embodiments, a wireless sensing system comprises a sensing transmitter (compare with 302 of FIG. 3) configured to transmit the plurality of sensing bursts and one or more sensing receiver(s) (compare with 303 of FIG. 3) configured to perform sensing measurements based on the sensing packets.

For example, the sensing transmitter and/or the sensing receiver(s) may be compliant with a Bluetooth specification and/or an IEEE 802.11 specification.

The wireless sensing system also comprises a sensing control node as described and exemplified herein (compare with 301 of FIG. 3 and with 510 of FIG. 5). The wireless sensing system may also comprise a wireless sensing node for determining and/or using the sensing result (compare with 304 of FIG. 3).

As already mentioned, the sensing control node may be a separate sensing control node, or may be comprised in a device with other sensing tasks as well (e.g., a sensing transmitter, a sensing receiver, or a wireless sensing node). Similarly, the wireless sensing node may be a separate wireless sensing node, or may be comprised in a device with other sensing tasks as well (e.g., a sensing transmitter, a sensing receiver, or a sensing control node).

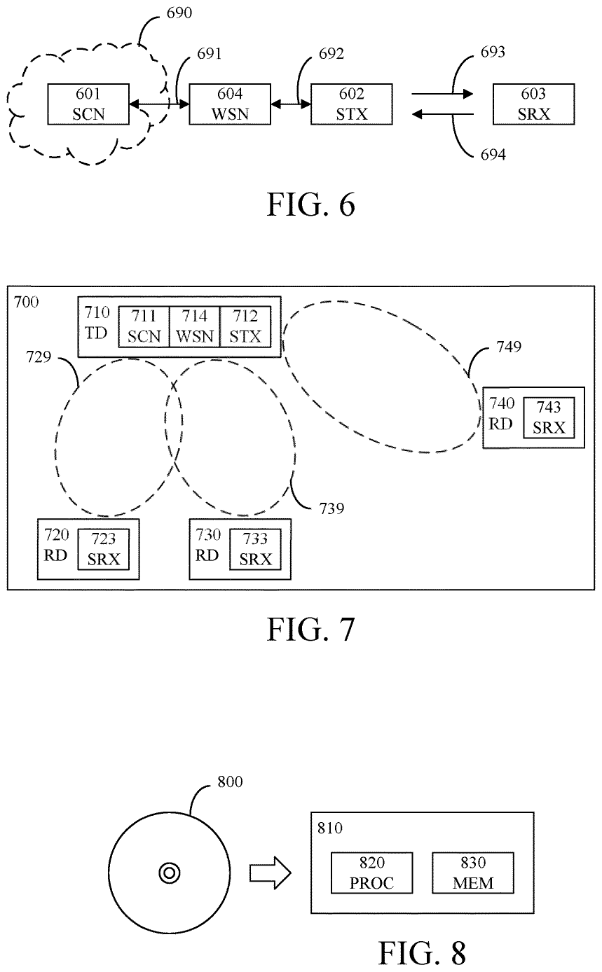

FIGS. 6 and 7 schematically illustrate example wireless sensing systems according to some embodiments.

In FIG. 6, the wireless sensing system comprises a sensing transmitter (STX) 602 (compare with 302 of FIG. 3) and a sensing receiver (SRX) 603 (compare with 303 of FIG. 3), along with a wireless sensing node (WSN) 604 (compare with 304 of FIG. 3). Sensing control (e.g., according to the method 100 of FIG. 1) is provided as a cloud service as illustrated by 690. Thus, the sensing control node (SCN) 601 (compare with 301 of FIG. 3) may be embodied as a cloud server.

For example, the WSN 604 may communicate with the SCN 601 over a connection 691 to acquire suitable parameters and/or control signaling for a sensing session. For example, the WSN 604 may provide the SCN 601 with sensing application requirements and other conditions for the sensing (e.g., receiver bandwidths, etc.), and the SCN 601 may respond with suitable parameter values and/or control signaling to be used for the sensing session.

Then, the WSN 604 may provide the control signaling to the sensing transmitter 602 over a connection 692 which may forward relevant portions of it to the sensing receiver(s) 603. The sensing transmitter 602 transmits the sensing bursts as instructed (illustrated by 693). The sensing receiver(s) 603 reports the sensing measurement result to the sensing transmitter 602 (illustrated by 694), and the sensing measurement result (or a processed version thereof) is conveyed over the connection 692 from the sensing transmitter 602 to the WSN 604.

FIG. 7 illustrates an example wireless sensing system deployment within a physical environment 700. For example, the physical environment 700 may be an indoor space, such as a room.

In FIG. 7, the wireless sensing system comprises a transmitter device (TD) 710 and a plurality of receiver devices (RD) 720, 730, 740. Each receiver device 720, 730, 740 comprises a respective sensing receiver (SRX) 723, 733, 743 (compare with 303 of FIG. 3).

The transmitter device 710 comprises a sensing transmitter (STX) 712 (compare with 302 of FIG. 3), a wireless sensing node (WSN) 714 (compare with 304 of FIG. 3), and a sensing control node (SCN) 711 (compare with 301 of FIG. 3). Thus, the sensing control node is collocated with the sensing transmitter and the wireless sensing node; namely in that the sensing control node, the sensing transmitter, and the wireless sensing node are comprised in a same transmitter device 710.

For example, the TD 710 may be an IEEE 802.11 AP and the RDs 720, 730, 740 may be IEEE 802.11 STAs.

The sensing control node 711 may be configured to perform one or more steps as described for the method 100 of FIG. 1; e.g., to enable the wireless sensing node 714 to achieve motion detection with at least some spaces 729, 739, 749 of the physical environment 700.

Generally, it should be noted that features and advantages described herein in connection with one of the Figures, may be equally applicable—mutatis mutandis—for one or more of the other Figures; even if not explicitly mentioned in connection thereto.

As already mentioned, it may be problematic to achieve sensing measurements over a relatively large sensing bandwidth and/or at regular time intervals. One or both of these problems are solved by various embodiments as presented herein.

As already explained, some embodiments use frequency hopping to synthesize sensing measurement corresponding to a wideband channel (i.e., a relatively large channel bandwidth).

At least some of the suggested approaches may be applied in the context of Bluetooth (where frequency hopping is well established) and/or in the context of IEEE 802.11 (where a framework for wireless sensing is being developed).

Bluetooth utilizes narrowband channels. Thus, direct application of wireless sensing in the context of Bluetooth would provide very limited resolution for the sensing, and thereby limit the usefulness and utility of the sensing results. Application of approaches according to some embodiments solves this problem and increases the relevance and usefulness of wireless sensing in the context of Bluetooth.

For IEEE 802.11, there is typically an asymmetry in the capabilities of APs and STAs. For example, the maximum output power and/or the maximum bandwidth (for transmission and/or reception) may be more limited for STAs than for APs, which may pose problems for high-resolution sensing (i.e., sensing over a relatively large sensing bandwidth). Application of approaches according to some embodiments solves this problem and increases the achievable sensing resolution in the context of IEEE 802.11.

For example, a STA with 80 MHz bandwidth which does not support sensing cannot be used as sensing receiver (performing and reporting sensing measurements). However, it could be used as a sensing transmitter. For example, an AP can configure the STA to perform UL transmissions (e.g., buffer status reports) which may be used as sensing packets by the AP acting as a sensing receiver. However, when the path loss is high, the quality of the sensing measurements could be very poor. As already mentioned, the signal quality requirements for sensing may differ from (e.g., be stricter than) those of “normal” communications. For example, an SNR value could be high enough for communications, but not for detection of changes in the propagation channel caused by the motion of a small object. To address this problem, the STA could be configured to transmit in a sub-channel (e.g., 40 MHz or 20 MHz) instead. Such an approach could enable higher SNR since the power spectrum density can be increased by concentrating the output power in frequency. However, resolution would be reduced. Thus, there is a trade-off between signal quality and resolution, which can be overcome (or at least relaxed) by application of approaches according to some embodiments in the context of IEEE 802.11.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a sensing control node.

Embodiments may appear within an electronic apparatus (such as a sensing control node) comprising arrangements, circuitry, and/or logic according to any of the embodiments described herein. Alternatively or additionally, an electronic apparatus (such as a sensing control node) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 8 illustrates an example computer readable medium in the form of a compact disc (CD) ROM 800. The computer readable medium has stored thereon a computer program comprising program instructions. The computer program is loadable into a data processor (PROC; e.g., a data processing unit) 820, which may, for example, be comprised in a sensing control node 810. When loaded into the data processor, the computer program may be stored in a memory (MEM) 830 associated with, or comprised in, the data processor. According to some embodiments, the computer program may, when loaded into, and run by, the data processor, cause execution of method steps according to, for example, the method illustrated in FIG. 1, or otherwise described herein.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

1. A method for wireless sensing in a packet-based communication network, the packet-based communication network operating according to a predefined channelization structure with sub-channels, and the wireless sensing being performed over a sensing frequency range with a sensing bandwidth which comprises a plurality of the sub-channels, the method comprising:
causing transmission of a plurality of sensing bursts from a sensing transmitter, each sensing burst comprising a respective collection of sensing packets, each sensing packet being transmitted over one or more of the sub-channels of the sensing frequency range and having a packet bandwidth which is smaller than the sensing bandwidth, and at least two sensing packets of each respective collection being transmitted over different sub-channels.

2. (canceled)

3. The method of claim 1, wherein the packet bandwidth is associated with one or both of a sensing receiver bandwidth and a packet power metric.

4. The method of claim 1, wherein transmission of one of the sensing bursts:
one or both covers the sensing frequency range and utilizes all sub-channels of the sensing frequency range; or
one or both covers only part of the sensing frequency range and utilizes only a subset of the sub-channels of the sensing frequency range.

5. The method of claim 1, wherein transmission of the plurality of sensing bursts:
one or both covers the sensing frequency range and utilizes all sub-channels of the sensing frequency range; or
one or both covers only part of the sensing frequency range and utilizes only a subset of the sub-channels of the sensing frequency range.

6. The method of claim 1, further comprising:
causing a sensing receiver to perform sensing measurements based on the sensing packets.

7. The method of claim 6, wherein causing the sensing receiver to perform sensing measurements comprises providing information indicative of a duration between sensing packets transmitted over a same sub-channel.

8. The method of claim 1, further comprising causing one or both interpolation and extrapolation of sensing measurements performed for utilized sub-channels, to provide sensing measurement estimations for un-utilized sub-channels.

9. The method of claim 1, further comprising determining one or more of:
a sensing session duration;
number of bursts in a sensing session;
a burst duration;
number of sensing packets per burst;
a burst rate within sensing session;
a packet rate within bursts;
a sub-channel change rate; and
a sequence length for sub-channel changing.

10. (canceled)

11. (canceled)

12. The method of claim 1, wherein at least one of the sub-channels is used for sensing transmission at least twice during the sensing session, wherein time variations of the at least one sub-channel are detected by comparing sensing measurements corresponding to different sensing transmissions for the at least one sub-channel during the sensing session.

13. (canceled)

14. The method of claim 1, wherein the transmission of a plurality of sensing bursts implements probing of the sensing frequency range by respective probing of at least some of the sub-channels.

15. (canceled)

16. An apparatus for wireless sensing in a packet-based communication network, the packet-based communication network operating according to a predefined channelization structure with sub-channels, and the wireless sensing being performed over a sensing frequency range with a sensing bandwidth which comprises a plurality of the sub-channels, the apparatus comprising controlling circuitry configured to cause:
transmission of a plurality of sensing bursts from a sensing transmitter, wherein each sensing burst comprises a respective collection of sensing packets, each sensing packet being transmitted over one or more of the sub-channels of the sensing frequency range and having a packet bandwidth which is smaller than the sensing bandwidth, and at least two sensing packets of each respective collection being transmitted over different sub-channels.

17. (canceled)

18. The apparatus of claim 16, wherein the packet bandwidth is associated with one or both of a sensing receiver bandwidth, and a packet power metric.

19. The apparatus of claim 16, wherein transmission of one of the sensing bursts:
one or both covers the sensing frequency range and utilizes all sub-channels of the sensing frequency range; or
one or both covers only part of the sensing frequency range and utilizes only a subset of the sub-channels of the sensing frequency range.

20. The apparatus of claim 16, wherein transmission of the plurality of sensing bursts:
one or both covers the sensing frequency range and utilizes all sub-channels of the sensing frequency range; or
one or both covers only part of the sensing frequency range and utilizes only a subset of the sub-channels of the sensing frequency range.

21. The apparatus of claim 16, wherein the controlling circuitry is further configured to cause a sensing receiver to perform sensing measurements based on the sensing packets.

22. The apparatus of claim 21, wherein the controlling circuitry is configured to cause the sensing receiver to perform sensing measurements by causing provision of information indicative of a duration between sensing packets transmitted over a same sub-channel.

23. The apparatus of claim 16, wherein the controlling circuitry is further configured to cause one or both interpolation extrapolation of sensing measurements performed for utilized sub-channels, to provide sensing measurement estimations for un-utilized sub-channels.

24. The apparatus of claim 16, wherein the controlling circuitry is further configured to cause determination of one or more of:
a sensing session duration;
number of bursts in a sensing session;
a burst duration;
number of sensing packets per burst;
a burst rate within sensing session;
a packet rate within bursts;
a sub-channel change rate; and
a sequence length for sub-channel changing.

25. (canceled)

26. (canceled)

27. The apparatus of claim 16, wherein at least one of the sub-channels is used for sensing transmission at least twice during the sensing session, wherein time variations of the at least one sub-channel are detected by comparing sensing measurements corresponding to different sensing transmissions for the at least one sub-channel during the sensing session.

28. (canceled)

29. The apparatus of claim 16, wherein the transmission of a plurality of sensing bursts implements probing of the sensing frequency range by respective probing of at least some of the sub-channels.

30.-32. (canceled)
